(19) United States
(12) Patent Application Publication
(10) Pub. No.: US 2017/0082172 A1
(43) Pub. Date: Mar. 23, 2017

(54) BALANCE SHAFT

(71) Applicant: Hirschvogel Umformtechnik GmbH, Denklingen (DE)

(72) Inventor: Hans BRITZGER, Denklingen (DE)

(73) Assignee: Hirschvogel Umformtechnik GmbH, Denklingen (DE)

(21) Appl. No.: 15/273,853

(22) Filed: Sep. 23, 2016

(30) Foreign Application Priority Data
Sep. 23, 2015 (DE) 10 2015 218 281.9

(51) Int. Cl. F16F 15/26; F16C 3/18

(52) U.S. Cl. CPC F16F 15/264; F16C 3/18

(57) ABSTRACT

A balance shaft for balancing forces of inertia and/or moments of inertia of a reciprocating-piston internal combustion engine, including: at least one elongate main body; at least one bearing seat disposed on the elongate main body, for the mounting of a radial bearing, wherein in the center point of the bearing seat is provided the rotational axis of the balance shaft. On the elongate main body is provided at least one unbalance portion the center of mass of which lies outside the rotational axis of the balance shaft. On the at least one unbalance portion substantially no material is provided in the region of the rotational axis of the balance shaft. A method for producing such a balance shaft is also provided.

This nonprovisional application claims priority under 35 U.S.C. §119(a) to German Patent Application No. 10 2015 218 281.9, which was filed in Germany on Sep. 23, 2015, and which is herein incorporated by reference.

### BACKGROUND OF THE INVENTION

Field of the Invention

The present invention relates to a balance shaft for balancing forces of inertia and/or moments of inertia of a reciprocating-piston internal combustion engine and to a method for producing such a balance shaft.

Description of the Background Art

From the prior art, a multiplicity of balance shafts are known. Usually balance shafts are produced by means of a hot forming process, in particular by means of a drop forging process, from a rod-shaped shaft blank.

Balance shafts of this type are frequently provided as integrally configured solid components, which, though they exhibit high stability, have a comparatively high component weight. As a result, these balance shafts have a comparatively high mass fraction which during operation provides no corresponding balancing force, or this mass fraction must be partially compensated by additional masses so as not to create unwanted unbalances during operation.

By contrast, in the development of modern balance shafts, there is the intention to reduce as far as possible the overall weight of the balance shaft in order to be able to reduce the masses to be accelerated, and thus also improve the consumption values of modern automobiles.

For instance, in printed publications EP 2 167 839 A1, which corresponds to U.S. Pat. No. 8,413,630, and DE 10 2011 087 535 A1, which corresponds to U.S. Pat. No. 8,939,124, it is proposed to economize on mass at the bearing surfaces or bearing seats of the balance shafts by providing these more or less only in the form of hollow bodies or only by way of corresponding partial surfaces.

### SUMMARY OF THE INVENTION

It is therefore an object of the present invention to define a balance shaft which has a lower overall weight or a still greater improved mass distribution.

A balance shaft according to an exemplary embodiment of the invention for balancing forces of inertia and/or moments of inertia of a reciprocating-piston internal combustion engine at least comprises: at least one elongate main body; at least one bearing seat, disposed on the elongate main body, for the mounting of a radial bearing, wherein in the center point of the bearing seat is provided the rotational axis of the balance shaft; wherein on the elongate main body is provided at least one unbalance portion, the center of mass of which lies outside the rotational axis of the balance shaft; and wherein on the at least one unbalance portion substantially no material is provided in the region of the rotational axis of the balance shaft.

In other words, the present invention proposes to reduce the mass of the balance shaft in the region of the unbalance portions by providing in the unbalance portions, as far as possible, only masses which are necessary to provide the balancing forces. This is realized by virtue of the fact that in the region of the rotational axis of the balance shaft, on the at least unbalance portion, no material, and thus no masses, are any longer provided. As a result, the possibility exists, moreover, of bringing the masses of the balance shaft which are active for the balancing forces comparatively far onto or into the bearing seats, so that, from this aspect too, an improved mass distribution of a balance shaft according to the invention is obtained.

Preferably, in the region also of the at least one bearing seat, substantially no material is provided in the region of the rotational axis of the balance shaft. In this context, it is preferred to provide a bearing receptacle or a bearing seat by way of a bearing inner ring which is formed onto the main body and onto which the bearing can subsequently be slipped or clipped. Such a bearing inner ring can be provided, for instance, by virtue of the fact that two appropriately shaped shoulder regions, which together form the bearing inner ring, are formed onto the main body. In other words, a bearing inner ring, onto which the bearing can subsequently be slipped or clipped, is formed by the two shoulder regions. Alternatively, the possibility exists of providing a bearing already complete with a bearing inner ring and to slip said bearing preferably laterally onto the bearing_seat. In this case, prior to the slip-on operation however, an appropriate contact surface (preferably likewise in the form of a shoulder) for the bearing (more precisely for the bearing inner ring) would have to be provided on the main body. The bearing can then be slipped onto the main body and brought into engagement with the contact surface. Subsequently a second shoulder is formed on the main body by forming, in particular by a calibration, so that the bearing can be held or received by the two shoulders.

Preferably, the balance shaft comprises on the elongate main body at least two adjacent unbalance portions, between which a connecting portion is provided. Depending on the design of the balance shaft, the connecting portion of two adjacent unbalance portions can run through the rotational axis of the balance shaft. Thus the connecting portion is preferably, as far as possible, the sole portion of the balance shaft which has material in the region of the rotational axis. Such a connecting portion is preferably provided when the centers of mass of the at least two adjacent unbalance portions are provided on opposite sides of the rotational axis, as is the case, for instance, in balance shafts for 3-cylinder engines.

Advantageously, the balance shaft is of substantially point-symmetrical configuration, wherein the center of symmetry of the balance shaft is preferably provided in the connecting portion connecting the two adjacent unbalance portions. The term substantially point-symmetrical should here be taken to mean that at least the elongate main body is of substantially point-symmetrical configuration, without account herein being taken of the (drive) engagement elements which are preferably arranged on the end portions.

Advantageously, at least one bearing seat is provided laterally on the at least one unbalance portion and/or within the unbalance portion. In other words, it is preferred that the bearing seat or seats is/are brought as close as possible to the unbalance portion. In an embodiment in which the bearing seat is disposed within the unbalance portion, the mass on the unbalance portion is also not arranged in a rotationally symmetrical manner, but rather acts as a kind of unbalance.

Preferably, the at least one unbalance portion at least partially corresponds to the partial shape of a hollow body which comprises at least side walls running parallel to the rotational axis of the balance shaft. The term “parallel to the rotational axis” should here be interpreted broadly and comprises not only straight side walls, but also bent or curved side walls which extend with their longitudinal axis substantially parallel to the rotational axis.

The at least one unbalance portion can be at least partially of shell-shaped, tub-shaped and/or notch-shaped configuration. In addition, a plurality of differently or substantially like configured unbalance portions can be provided on the elongate main body.

In addition, it is of advantage if the elongate main body or unbalance portions has/have different material densities and/or different wall thicknesses. As a result, the possibility in turn exists of adapting the unbalance of the balance shaft or of increasing it still further.

Advantageously, the unbalance portion is arranged offset from the rotational axis of the balance shaft. As a result, a simple possibility exists of being able to appropriately influence the generated balancing forces.

Preferably, an engagement element, for example, a conical engagement element, can be provided on at least one end portion of the balance shaft in order to be able to connect the balance shaft to a drive, in particular a chain wheel drive.

The present invention further relates to a method for producing a balance shaft, comprising at least the following steps: provision of at least one elongate main body, performance of at least one forming operation, which is performed substantially perpendicular to the rotational axis of the balance shaft such that on the elongate main body at least one unbalance portion is formed, wherein the center of mass of the unbalance portion lies outside the rotational axis of the balance shaft, and wherein on the at least one unbalance portion substantially no material remains in the region of the rotational axis of the balance shaft. The forming can here be realized, for instance, by means of a forge forming process carried out perpendicular to the rotational axis. In this, the desired shape can be provided through the use of one forming step or several individual forming steps.

A forging-based forming process means that it is here immaterial on which specific end contour this is based, since a, along the force flow, optimal fiber course on the component can thereby be ensured. Thus a forging-based forming process allows the material properties to be optimally exploited. In particular, nor must any further mass normally be introduced in order to increase the strength. As a result of the fiber course established by forging, optimal conditions in the region of the bearing seats can also be ensured, wherein it is particularly advantageous if in this region the fibers run parallel to the needle bearings. Advantageously, for this reason, influence is also actively brought to bear on the run-in behavior of the needle bearings in the bearing seat, which run-in behavior is reduced to a minimum. As a result of the fiber course established by forging, the warpage of the component along the rotational axis can also be reduced, which in turn has a positive effect on the reproducibility of the unbalance mass.

By means of a forging-based forming process, complex geometries in the form of a monobloc variant are able to be produced.

Further scope of applicability of the present invention will become apparent from the detailed description given hereinafter. However, it should be understood that the detailed description and specific examples, while indicating preferred embodiments of the invention, are given by way of illustration only, since various changes, combinations and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic view of a first embodiment of a balance shaft according to the invention;

FIG. 2 shows a further schematic view of the balance shaft from FIG. 1;

FIG. 3 shows a schematic view of a second embodiment of a balance shaft according to the invention; and

FIG. 4 shows a schematic view of a third embodiment of a balance shaft according to the invention.

### DETAILED DESCRIPTION

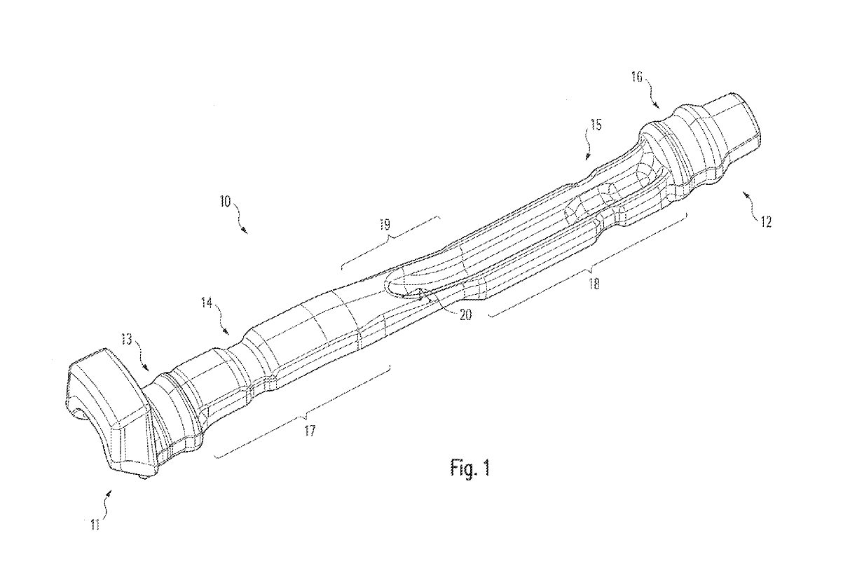

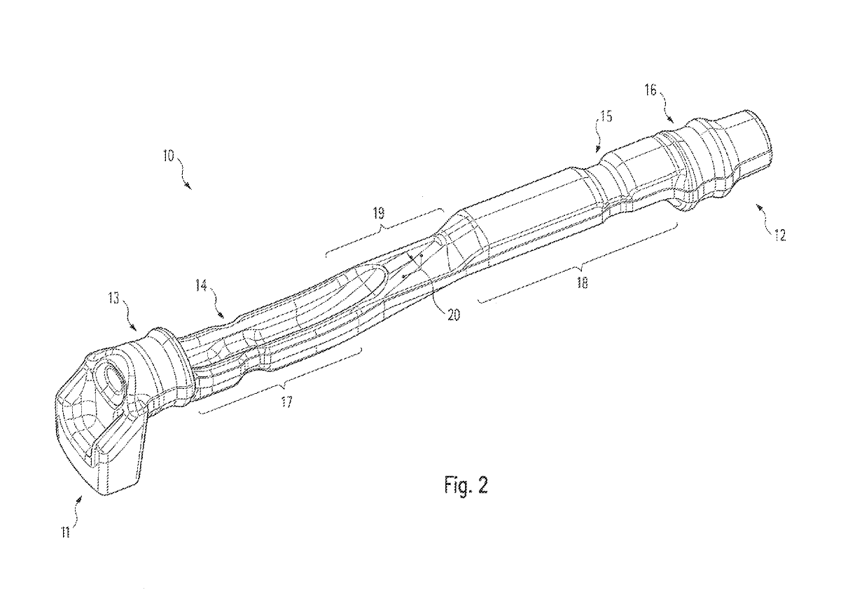

FIGS. 1 and 2 show a first embodiment of a balance shaft 10 according to the invention. The balance shaft 10 comprises on opposite end portions two engagement elements 11, 12, with which the balance shaft 10 is connectable to a drive, in particular a chain drive.

In addition, in this preferred embodiment the balance shaft 10 comprises four bearing seats 13, 14, 15, 16 for the mounting of a radial bearing. In the center point of the bearing seats 13, 14, 15, 16 lies the rotational axis of the balance shaft 10.

The bearing seats 13, 16 can here respectively have a bearing inner ring, on which a bearing, for example, a roller bearing, can respectively be arranged. In this context, it is preferred to provide a bearing seat 13, 16 by way of a bearing inner ring which is formed onto the main body and onto which the bearings can subsequently be slipped or clipped. Such a bearing inner ring can be provided, for instance, by virtue of the fact that two appropriately shaped shoulder regions (not shown), which, joined together, respectively form a bearing inner ring, are formed onto the main body. In other words, a bearing inner ring, onto which the bearing can subsequently be slipped or clipped, can respectively be formed by the two shoulder regions. Alternatively, the possibility also exists of providing the bearings already complete with a bearing inner ring and of respectively slipping this composite laterally onto the bearing seat 14, 15. In this case, it is preferred that, prior to the slip-on operation, an appropriate contact surface, for example, in the form of a shoulder, for the bearing (more precisely for the bearing inner ring) is respectively provided on the main body. The composite of bearing and bearing inner ring can then respectively be slipped onto the main body and brought into engagement with the contact surface. Subsequently a second shoulder is formed on the main body by forming, in particular by a calibration (i.e. through a so-called calibration stroke), so that the bearing inner rings, and thus the bearings, can be held or received by the two shoulders.

As can clearly be seen in FIGS. 1 and 2, the balance shaft 10 comprises two unbalance portions 17, 18, which are connected to each other by a connecting portion 19. The unbalance portions 17, 18 are here of tub-shaped configuration with lateral walls, so that substantially no material is arranged in the region of the rotational axis. Alternatively to the shown tub shape, the unbalance portions 17, 18 can also be of shell-shaped or notch-shaped configuration.

By means of the represented tub shape, non “effectively” used material in the region of the rotational axis can thus be avoided or considerably reduced, so that the component can be correspondingly reduced in weight. Preferably, stiffening measures on the component can thereby also be avoided.

A further advantage of the material saving is that the connecting body (i.e. the tub shape) between the two connecting bodies is more easily twistable, which has a positive effect on the anticipated noise development upon the start-up of the balance shaft, in that the noise development (a “rattling”) between the two drive wheels, on the balance shaft and crankshaft sides is reduced. The necessary or maximal stiffness of the tub shape can here be controlled via stiffening ribs (framework) introduced by forging.

By virtue of a forging-based production, restrictions in terms of length and employed wall thicknesses barely exist.

Through the proposed geometry of the unbalance portions 17, 18, i.e. through the reduction of that mass of the unbalance portions 17, 18 which is not necessary for the balancing forces, the possibility exists of reducing the mass of a balance shaft 10 according to the invention to the bare essential. The possibility also exists of providing the bearing seats 14, 15 at least partially or fully in the region of the tub-shaped unbalance portions 17, 18, so that the unbalance portions 17, 18 are in no way interrupted by the bearing seats 14, 15, but rather mass can be provided also at the bearing seats 14, 15 in order to provide balancing forces.

In the exemplary embodiments shown in FIGS. 1 to 3, the centers of gravity of the unbalance portions 17, 18, 17′, 18′ are here arranged on opposite sides of the rotational axes of the balance shafts 10, 10′. This arrangement is provided, for instance, for 3-cylinder engines. As can likewise clearly be seen in FIGS. 1 to 3, the unbalance portions 17, 18, 17′, 18′ are arranged in a point-symmetrical manner, wherein the centers of symmetry 20, 20′ are respectively arranged in the region of the connecting portions 20, 20′.

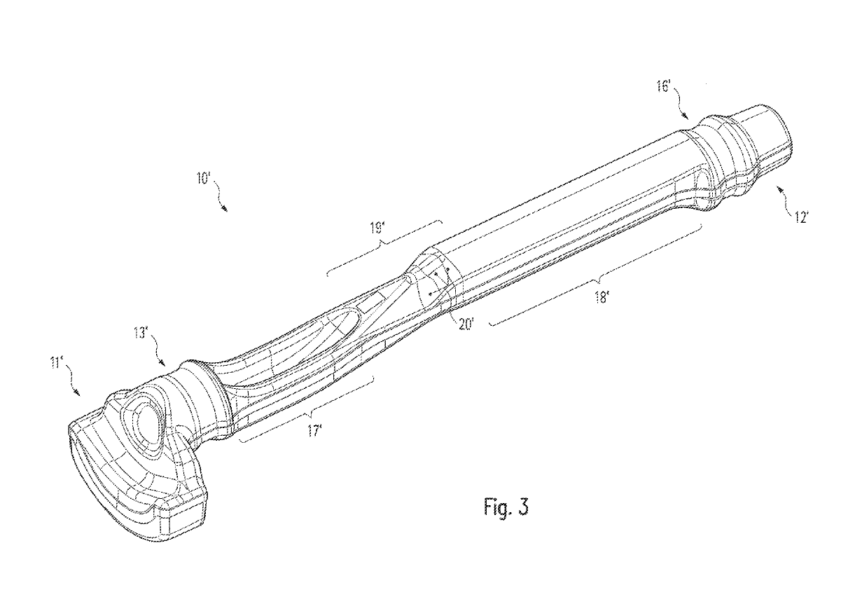

FIG. 3 shows an embodiment of a balance shaft 10′ according to the invention. The embodiment shown in FIG. 3 substantially corresponds to that embodiment of the balance shaft 10 which is shown in FIGS. 1 and 2. Same parts are therefore provided with same apostrophized reference symbols. Unlike the embodiment shown in FIGS. 1 and 2, the balance shaft 10′ shown in FIG. 3 comprises no bearing seats within the unbalance portions 17′, 18′, but just two bearing seats 13′, 16′ arranged laterally on the unbalance portions 17′, 18′.

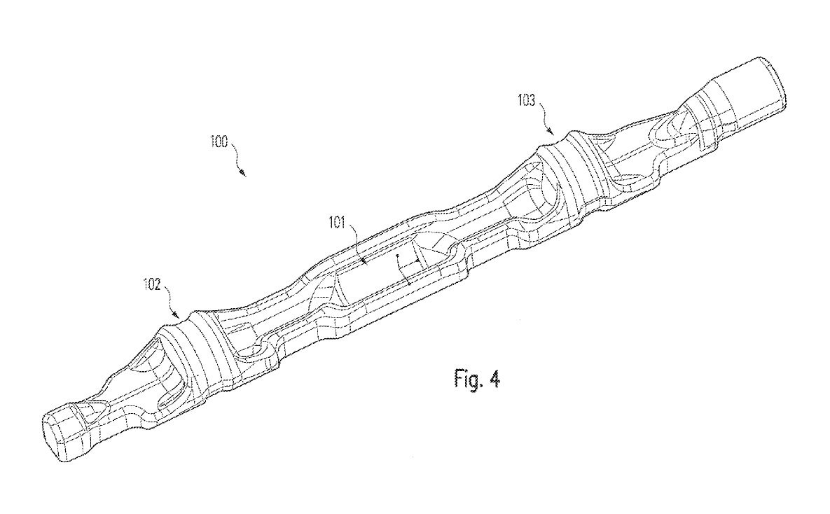

FIG. 4 shows an embodiment of a balance shaft 100 according to the invention. Here, the balance shaft 100 comprises an unbalance portion which runs on one side of the rotational axis and which extends substantially over the entire longitudinal extent of the balance shaft 100. The unbalance portion here comprises at least one tub-shaped region 101. As can also clearly be seen in FIG. 4, the unbalance portion can comprise various sections having different widths. The balance shaft 100 likewise comprises two bearing seats 102, 103, on which appropriate bearings, for example, roller bearings, can be arranged. The balance shaft 100 shown in FIG. 4 is here of substantially mirror-symmetrical configuration, wherein the axis of symmetry is provided in the tub-shaped region 101 of the balance shaft 100.

The present invention is not limited to the preceding illustrative embodiments, as long as it is embraced by the subject of the following claims. Furthermore, the preceding illustrative embodiments are mutually combinable and intercombinable in any chosen manner. In particular, besides the shown tub-shaped unbalance portions, other geometries, for instance shell-shaped or notch-shaped geometries, can alternatively or additionally be provided. The centers of mass of the unbalance portions can also be still further altered relative to the rotational axis of the balance shaft by a displacement of the mass of the main body and/or by an offset arrangement of the main body from the rotational axis of the balance shaft. Various additional (separately or integrally configured) balancing weights can also be provided in the main body (preferably in the region of the unbalance portions). Finally, it should be pointed out that the respective masses or the bearing seats of the balance shaft can be adapted, with respect to their arrangement along the rotational axis, to the respectively specific installation environment.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A balance shaft for balancing forces of inertia and/or moments of inertia of a reciprocating-piston internal combustion engine, the balance shaft comprising:
at least one elongate main body;
at least one bearing seat disposed on the elongate main body for mounting a radial bearing, wherein in a center point of the bearing seat a rotational axis of the balance shaft is provided; and
at least one unbalance portion provided on the elongate main body, the at least one unbalance portion having a center of mass that lies outside the rotational axis of the balance shaft,
wherein on the at least one unbalance portion substantially no material is provided in a region of the rotational axis of the balance shaft.

2. The balance shaft according to claim 1, wherein, on the at least one bearing seat, substantially no material is provided in the region of the rotational axis of the balance shaft.

3. The balance shaft according to claim 1, wherein the elongate main body comprises at least two adjacent unbalance portions between which a connecting portion is provided that runs through the rotational axis of the balance shaft.

4. The balance shaft according to claim 3, wherein the centers of mass of the at least two adjacent unbalance portions are provided on opposite sides of the rotational axis.

5. The balance shaft according to claim 1, wherein the balance shaft is of substantially point-symmetrical configuration.

6. The balance shaft according to claim 1, wherein the balance shaft is of substantially mirror-symmetrical configuration and the axis of symmetry runs substantially perpendicular or perpendicular to the rotational axis.

7. The balance shaft according to claim 1, wherein at least one bearing seat is provided laterally on the at least one unbalance portion and/or within the unbalance portion.

8. The balance shaft according to claim 1, wherein the connecting body is configured such that this is twistable to establish a reduced noise development upon the start-up of the balance shaft.

9. The balance shaft according to claim 1, wherein the at least one unbalance portion at least partially corresponds to a partial shape of a hollow body which comprises at least side walls running parallel to the rotational axis of the balance shaft.

10. The balance shaft according to claim 9, wherein the unbalance portion is at least partially of shell-shaped, tub-shaped and/or notch-shaped configuration.

11. The balance shaft according to claim 1, wherein the at least one unbalance portion has different wall thicknesses.

12. The balance shaft according to claim 1, wherein the unbalance portions is arranged offset from the rotational axis of the balance shaft.

13. The balance shaft according to claim 1, wherein the balance shaft has on at least one end portion an engagement element, which is configured such that the balance shaft is connectable to a drive or a chain wheel drive.

14. The balance shaft according to claim 1, wherein a center of symmetry of the balance shaft is provided in a connecting portion connecting two adjacent unbalance portions.

15. A method for producing a balance shaft according to claim 1, the method comprising:
providing at least one elongate main body; and
performing at least one forming operation, which is performed substantially perpendicular to the rotational axis of the balance shaft such that on the elongate main body at least one unbalance portion is formed,
wherein the center of mass of the unbalance portion lies outside the rotational axis of the balance shaft, and
wherein on the at least one unbalance portion substantially no material remains in the region of the rotational axis of the balance shaft.
